(19) United States
(12) Patent Application Publication
(10) Pub. No.: US 2026/0168439 A1
(43) Pub. Date: Jun. 18, 2026

(54) COOLING SYSTEM FOR MITIGATING FUEL NOZZLE COKING IN A GAS TURBINE ENGINE

(71) Applicant: GENERAL ELECTRIC COMPANY, Evendale, OH (US)

(72) Inventors: Liangjun Qiu, Shanghai (CN); Guohua Zhong, Shanghai (CN); Weili Yang, West Chester, OH (US); Ning Fang, West Chester, OH (US); Weizeng Kong, West Chester, OH (US)

(21) Appl. No.: 18/985,420

(22) Filed: Dec. 18, 2024

(51) Int. Cl. F02C 7/18; F02C 7/12; F02C 9/16

(52) U.S. Cl. CPC F02C 7/185; F02C 7/12; F02C 9/16

(57) ABSTRACT

A cooling system for post shutdown cooling of an aircraft engine using the aircraft's environmental control system (ECS) includes a cooling blower and a valve system. The valve system includes a blower valve disposed within the ECS between the cooling blower and the engine for enabling fluid communication between the cooling blower and the engine post shutdown of the engine and for disabling fluid communication between the cooling blower and the engine during operation of the engine. The valve system includes at least one ECS valve disposed within the ECS between a cabin of the aircraft and the engine for enabling fluid communication between the engine and the cabin of the aircraft during operation of the engine and for disabling fluid communication between the cooling blower and the cabin of the aircraft post shutdown of the engine.

### TECHNICAL FIELD

The present disclosure relates generally to mitigating fuel nozzle coking in gas turbine engines and, more particularly, to a cooling system for post shutdown cooling of a gas turbine engine of an aircraft.

### BACKGROUND

Upon shutdown, a typical gas turbine engine requires a period of time to return to ambient or near ambient temperature. Residual heat in the engine post-shutdown may cause unburnt fuel to reach coking temperature, which can result in coke deposits forming in the engine's fuel nozzles causing blockages. These fuel nozzle blockages may negatively affect engine operation such as, for example, fuel consumption performance, combustor performance, engine hardware performance due to thermal loading, etc. In the context of an aircraft engine, for example, coking of unburnt fuel may occur after engine shutdown post-flight and/or between flight legs. Fuel nozzle blockages in the aircraft's engine will call for regular inspections of the fuel nozzles and/or hardware replacement after a certain cumulative flight cycle of the aircraft. This impacts the on-wing engine time and is a maintenance burden resulting in added costs passed onto airline customers.

Accordingly, to assist with cooldown of a gas turbine engine post-shutdown to mitigate coking of unburnt fuel, a cooling system that provides air (e.g., ambient air) to an aircraft's gas turbine engine post-shutdown would be useful.

### BRIEF DESCRIPTION OF DRAWINGS

These and other features, aspects, and advantages of the present disclosure will become better understood when the following detailed description is read with reference to the accompanying drawings in which like characters represent like parts throughout the drawings, wherein:

FIG. 1 is a partial side view of an aircraft including a gas turbine engine, according to an aspect of the present disclosure;

FIG. 2 is a schematic diagram of the gas turbine engine of the aircraft of FIG. 1, according to aspects of the present disclosure;

FIG. 3 is a schematic diagram of an aircraft incorporating a cooling system for cooling the aircraft's engine post shutdown to mitigate fuel nozzle coking, according to aspects of the present disclosure; and

FIG. 4 is an exemplary flowchart outlining a method for post-shutdown cooling of an aircraft engine using the aircraft's environmental control system (ECS) to mitigate fuel nozzle coking, according to aspects of the present disclosure.

Repeat use of reference characters in the specification and drawings is intended to represent the same or analogous features or elements of the present disclosure.

### DETAILED DESCRIPTION

Although this disclosure will be described in terms of specific aspects, it will be readily apparent to those skilled in this art that various modifications, rearrangements, and substitutions may be made without departing from the spirit of this disclosure.

For the purpose of promoting an understanding of the principles of this disclosure, reference will now be made to exemplary aspects illustrated in the drawings, and specific language will be used to describe the same. It will nevertheless be understood that no limitation of the scope of this disclosure is thereby intended. Any alterations and further modifications of the features illustrated herein, and any additional applications of the principles of this disclosure, as illustrated herein, which would occur to one skilled in the relevant art and having possession of this disclosure, are to be considered within the scope of this disclosure.

Approximating language, as used herein, is applied to modify any quantitative representation that could permissibly vary without resulting in a change in the basic function to which it is related. Accordingly, a value modified by a term or terms, such as “about,” “approximately,” “generally,” and “substantially” is not to be limited to the precise value specified. In at least some instances, the approximating language may correspond to the precision of an instrument for measuring the value, or the precision of the methods or the machines for constructing the components and/or the systems or manufacturing the components and/or the systems. For example, the approximating language may refer to being within a one, two, four, ten, fifteen, or twenty percent margin in either individual values, range(s) of values and/or endpoints defining range(s) of values.

During normal operations, temperatures of gas turbine engine components are maintained within allowable limits by a plurality of cooling processes that transfer heat from the components to one or more heat sinks. When the engine is shutdown, most cooling systems no longer operate. Residual heat in certain engine components (e.g, “soakback”) can increase the temperature of other engine components beyond allowable limits. A particular concern is the formation of carbon (or “coke”) deposits in fuel carrying components including fuel nozzles when a hydrocarbon fuel (liquid or gas) is exposed to high temperatures in the presence of oxygen. Some known methods of mitigating coking include rotating the rotor post shutdown of the engine (e.g., “motoring”) or purging the engine with forced air provided from an Auxiliary Power Unit (“APU”), ground power unit (“GPU”), or air conditioning unit post shutdown of the engine. One problem with these methods is that they require resources such as fuel, external equipment, and/or logistical support that may be unavailable or impractical.

The present disclosure addresses the foregoing by coupling an onboard cooling blower (e.g., a fan blower) to an aircraft's ECS for supplying cooling air to the aircraft's engine post shutdown to prevent unburnt fuel from reaching coking temperature and forming deposits in the engine's fuel nozzles. As used herein, an engine is considered to be “shutdown” when fuel is not being supplied to the engine's combustor. To selectively supply cooling air to the aircraft's engine via the cooling blower post engine shutdown, a valve system including a plurality of valves (e.g., solenoid valves) is utilized to control the flow of air through the aircraft's ECS for selectively placing the cooling blower in fluid communication with the aircraft's engine while disabling fluid communication via the ECS between the cooling blower and the aircraft's cabin and/or the aircraft's APU. The cooling blower and the valve system may be controlled from within the aircraft (e.g., from the cockpit) to enable activation/deactivation of the cooling blower and opening/closing of valves within the valve system. The aircraft's existing electrical system may be utilized to supply the power to the cooling blower and/or the valve system via the aircraft electrical bus system. In aspects of the present disclosure, the cooling blower may be an AC-powered cooling blower that is powered by the aircraft's onboard APU. In aspects of the present disclosure, the cooling blower may be a DC-powered cooling blower that is powered by a DC power source such as, for example, the aircraft's onboard battery. During flight, the cooling blower is deactivated and the valve system is configured to enable the flow of air from the engine into the aircraft's ECS for supplying air conditioning to the aircraft's cabin while disabling fluid communication between the cooling blower and the engine. During flight, the valve system is also configured to disable fluid communication via the ECS between the cooling blower and the aircraft's cabin and/or the aircraft's APU.

After engine shutdown, the valve system is utilized to enable fluid communication between the cooling blower and the engine while disabling fluid communication between the cooling blower and the aircraft's cabin and/or the aircraft's APU. The cooling blower is then activated to provide cooling air to the engine. Deactivation of the cooling blower and/or actuation of select valves within the valve system may be achieved manually (e.g., via the pilot, aircraft personnel, maintenance crew, etc.), automatically in response to engine temperature feedback from a temperature sensor disposed within the engine, and/or automatically in response to expiration of a predetermined period of time as monitored by a timer. Conventional cooling systems for mitigating fuel nozzle coking in an aircraft engine are typically located within the aircraft's engine compartment or provided as ground equipment outside the aircraft. In contrast, the cooling blower of the present disclosure is part of and/or incorporated within the aircraft's ECS and may be positioned anywhere within the aircraft where there is more packaging space, lower temperatures, and less vibration.

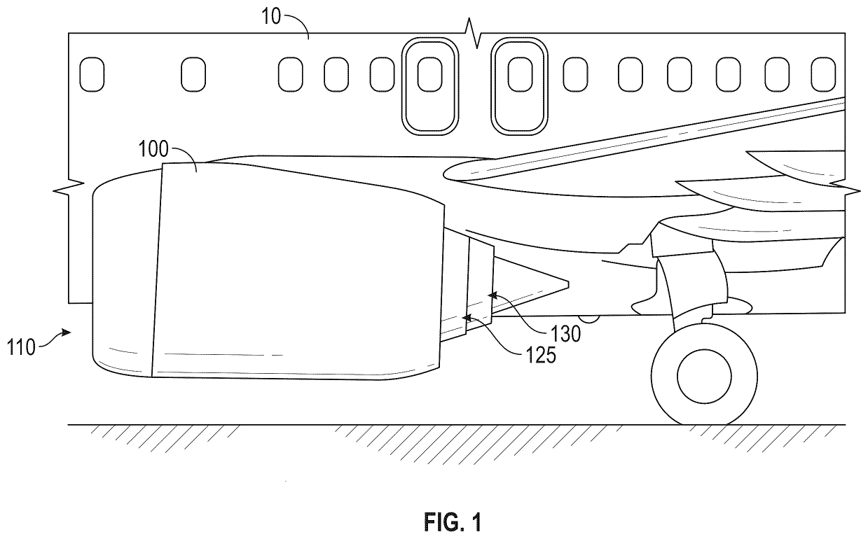

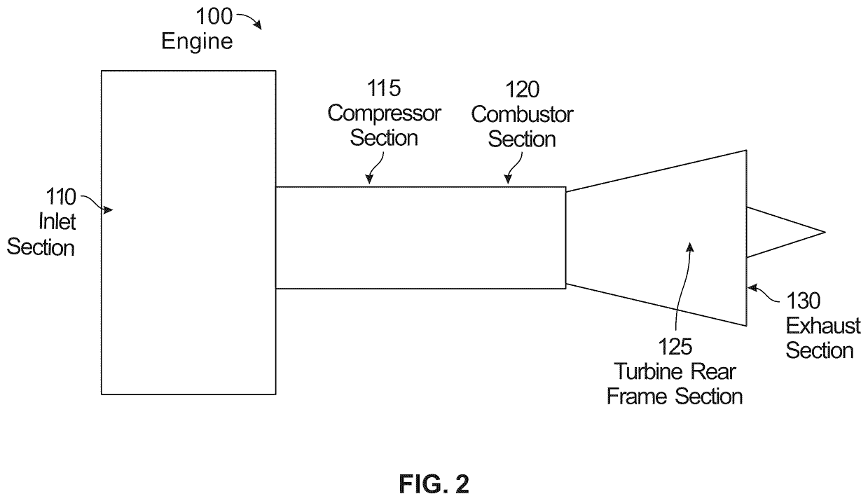

Referring to FIGS. 1 and 2, an aircraft 10 including one or more gas turbine engines 100 (two engines 100 shown), according to various exemplary embodiments of the present disclosure is shown. The engine 100 generally includes an inlet section 110, a compressor section 115, a combustor section 120, a turbine rear frame section 125, and an exhaust section 130. The exhaust section 130 defines an outlet for air that enters the engine 100 via the inlet section 110. It will be appreciated that, as a result of combustion gases produced by air entering the engine 100 combusting with fuel in the combustor section 120, at least a portion of the engine 100 reaches relatively high temperatures during operation of the engine 100. For at least some gas turbine engines, for example, the engine temperatures may be within a range of about 200° F. to about 3500° F., with the temperature varying in different sections of the engine 100. After the engine 100 is shut down, the temperature of certain engine components can remain elevated for several hours unless the heat is removed from the engine 100. That is, without a mechanism to remove heat from the engine 100 after it is shutdown, it may take several hours for the engine 100 to cool down to a temperature conducive to cleaning, inspection, and/or maintenance of the engine 100. In addition to extending the time to complete cleaning, inspection, and/or maintenance activities, such lengthy post-shutdown cool-down periods increase the potential for soakback coking of engine components, such as fuel nozzles located in the combustor section 120, which can degrade the components and, thus, degrade component life and engine performance. The present disclosure provides for a cooling system that utilizes the ECS of the aircraft 10 to cool the engine 100 of the aircraft 10 after engine shutdown. For example, the cooling system may be used to force air (e.g., ambient air) into the engine 100, for example, via a fluid coupling between a duct of the aircraft's ECS and any one or more existing ports of the engine 100.

As used herein, the engine 100 is considered to be “operating” or in “operation” when fuel is being is supplied to and burned in the combustor section, and the resulting combustion gases are driving rotation of at least the core of the engine 100. As used herein, the engine 100 is considered to be “shutdown” when fuel is not being supplied to the combustor. It will be understood that “operation” encompasses numerous operating conditions having varying rotor speeds and varying thrust and/or power outputs.

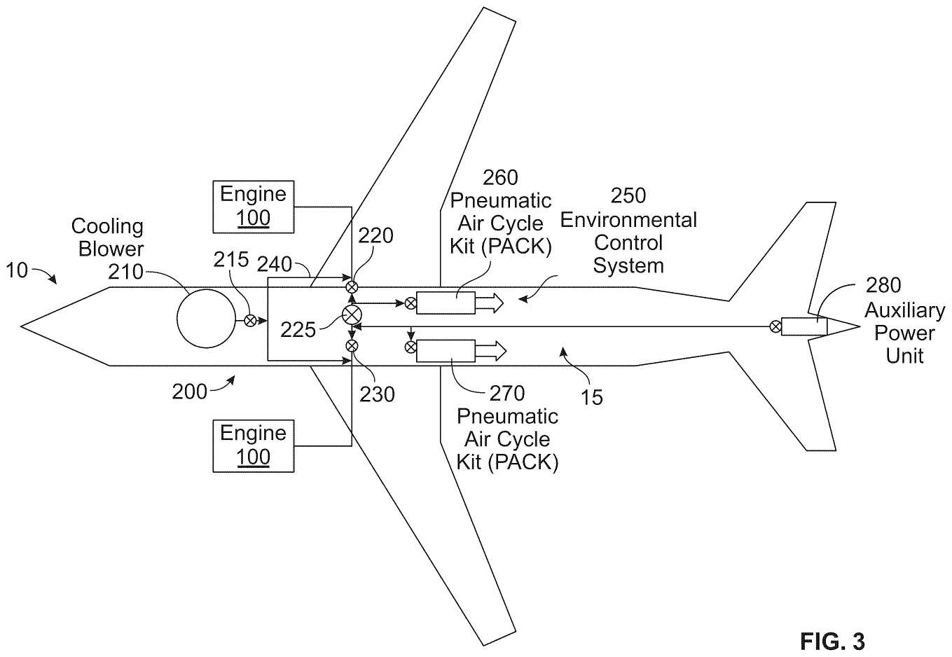

FIG. 3 provides a schematic view of the aircraft 10 of FIG. 1 including an Auxiliary Power Unit (APU) 280 and an exemplary cooling system 200 for cooling the engine 100 of the aircraft 10 after engine shutdown using an ECS 250 of the aircraft 10. The ECS 250 generally includes a Pneumatic Air Cycle Kit (PACK) system including a righthand side PACK 260 and a lefthand side PACK 270. The PACKs 260, 270 serve to condition the hot, high pressure bleed air from the engine 100 or from the APU 280 to provide air supply, thermal control, and cabin pressurization for the crew and passengers. The ECS 250 may also include a cross-bleed valve 225 that may be used to supply pressurized air bled from the compressor section 115 of the engine 100, upstream of the combustor section 120, to the PACKs 260, 270 for conditioning.

The cooling system 200 is part of and/or incorporated within the ECS 250 of the aircraft 10 and generally includes a cooling blower 210 and a blower valve 215 configured to selectively place the cooling blower 210 in fluid communication with the engine 100 such that the cooling blower 210 is enabled to provide cooling air to the engine 100 via the ECS 250 of the aircraft 10. In aspects of the present disclosure, the cooling system 200 may optionally include duct piping 240 that serves to fluidly couple the cooling blower 210 to the ECS 250. In this scenario, the blower valve 215 may be fluidly coupled to the duct piping 240 to control the flow of cooling air from the cooling blower 210 through the duct piping 240. In aspects of the present disclosure, the duct piping 240 may be eliminated and the cooling blower 210 and/or the blower valve 215 may be directly fluidly coupled to the ECS 250.

A pair of ECS valves 220, 230 control the flow of air from the engine 100 into the ECS 250. More specifically, the ECS valve 220 controls air flow from a righthand side engine 100 of the aircraft 10 to the righthand side PACK 260 and the ECS valve 230 controls air flow from a lefthand side engine 100 of the aircraft 10 to the lefthand side PACK 270. During flight, the cooling blower 210 is deactivated and the blower valve 215 is closed to prevent fluid communication between the cooling blower 210 and the engine 100 and between the cooling blower 210 and the ECS 250. The ECS valves 220, 230 are open during flight to enable the flow of bleed air from the engine 100 to the PACKs 260, 270 to enable the PACKs 260, 270 to condition the bleed air for supplying air conditioning to a cabin 15 of the aircraft 10.

Upon shutdown of the engine 100 (e.g., post flight and/or in between flight legs), the blower valve 215 is opened to enable fluid communication via the ECS 250 between the cooling blower 210 and the engine 100, and the cooling blower 210 is activated to provide cooling air to the engine 100. To manually control (e.g., actuate, activate/deactivate, open/close, etc.) the blower valve 215 and/or the cooling blower 210, a suitable control mechanism (e.g., button, switch, lever, or the like) is provided within the aircraft 10 (e.g., within the cockpit) for manual use by the pilot, aircraft personnel, and/or maintenance crew. While cooling the engine 100 using the cooling blower 210 post engine shutdown, the APU 280 may supply air to the PACKs 260, 270 for providing air conditioning to the cabin 15 of the aircraft 10. In this scenario, the ECS valves 220, 230 are closed to fluidly seal the cooling blower 210 and the engine 100 from the cabin 15 of the aircraft 10 and to prevent air provided from the cooling blower 210 from mixing with the air provided to the cabin 15 of the aircraft 10 by the APU 280. In aspects of the present disclosure, following shutdown of the engine 100, the cooling blower 210 may be activated for about twenty minutes to about sixty minutes for cooling the engine 100 before being deactivated to conclude the engine cooling process.

At the conclusion of the engine cooling process, the cooling system 200 may be deactivated (e.g., deactivation of the cooling blower 210 and closing of the blower valve 215) manually (e.g., by the pilot, aircraft personnel, and/or maintenance crew). Alternatively, the cooling system 200 may be deactivated automatically. For example, in aspects of the present disclosure, one or more temperature sensors may be disposed within the engine 100 for sensing engine temperature and providing a corresponding signal indicating the sensed temperature to the cooling system 200. If the sensed temperature signal received by the cooling system 200 indicates that the engine temperature is below a threshold temperature (e.g., less than coking temperature), the cooling system 200 may automatically deactivate the cooling blower 210 and/or close the blower valve 215 to conclude the engine cooling process. In aspects of the present disclosure, the cooling system 200 may include a timer configured to cause automatic deactivation of the cooling blower 210 at the expiration of a predetermined period of time. For example, the timer may be initiated by activation of the cooling blower 210 and set to expire after a predetermined period of time (e.g., about 20 minutes, about 30 minutes, about 45 minutes, about 60 minutes, etc.). Upon expiration of the predetermined period of time, the timer provides a corresponding signal to the cooling system 200 to automatically trigger deactivation of the cooling blower 210 and/or closing of the blower valve 215 to conclude the engine cooling process.

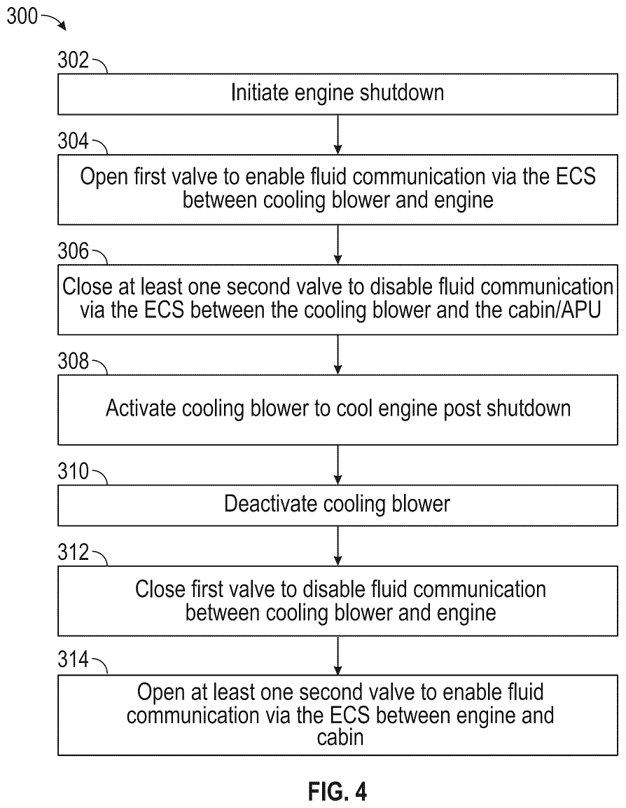

Referring now to FIG. 4, an exemplary flowchart outlining blocks of a method for mitigating fuel nozzle coking in a gas turbine engine (hereinafter, “method 300”) is generally provided. Embodiments of the method 300 may generally be utilized or implemented with embodiments of the aircraft 10 and engine 100 generally provided in FIGS. 1-3. However, it should be appreciated that the method 300 may be utilized or implemented with other embodiments of a gas turbine engine, such as, but not limited to, turbofan, turboprop, and turboshaft gas turbine engines, including single spool, two spool, three spool, or more, gas turbine engines. Furthermore, the method 300 includes steps presented in a sequence. However, it should be appreciated that steps of the method 300 may be re-arranged, re-ordered, re-sequenced, altered, omitted, or added to without removing from the scope of the present disclosure.

Following normal engine operations, engine shutdown is initiated at block 302, for example, by an engine controller (not shown) sending control commands to the engine 10. During a typical engine shutdown procedure, the engine controller shuts off a flow of fuel to the combustor section 120 (FIG. 2) after receiving a full stop command such that the rotational speed of the engine 100 decreases to a minimum speed at which the engine's rotor is continually turned (e.g., by an outside source) so as to prevent thermal bowing of the rotor. At block 304, the blower valve 215 is opened to enable fluid communication between the cooling blower 210 and the engine 100. At block 306, the ECS valves 220, 230 are closed to disable fluid communication via the ECS 250 between the cooling blower 210 and the aircraft's APU 280 and/or between the cooling blower 210 and the cabin 15 of the aircraft 10. Closure of the ECS valves 220, 230 at block 306 also serves to disable fluid communication via the ECS 250 between the engine 100 and the aircraft's APU 280 and/or between the engine 100 and the cabin 15 of the aircraft 10.

At block 308, the cooling blower 210 is activated and forces air (e.g., ambient air) through the ECS 250 and into the engine 100 to cool the engine 100. During cooling of the engine 100 using the cooling blower 210 after engine shutdown, the aircraft's APU 280 may supply air to the PACKs 260, 270 for providing air conditioning to the cabin 15 of the aircraft 10.

To conclude the cooling process, the cooling blower 210 is deactivated at block 310 and the blower valve 215 is closed to disable fluid communication between the cooling blower 210 and the engine 100 at block 312. The cooling process may be concluded either manually (e.g., via manual deactivation of the cooling blower 210 and/or closing of the blower valve 215) or automatically (e.g., in response to a sensed engine temperature or termination of a predetermined period of time).

Once the cooling blower 210 is deactivated and the blower valve 215 is closed, the ECS valves 220, 230 are opened to enable fluid communication between the engine 100 and the cabin 15 of the aircraft 10 at block 314. As such, during in-flight engine operations, the engine 100 may provide bleed air to the PACKs 260, 270 via the ECS 250 for air conditioning the cabin 15 of the aircraft 10.

With the foregoing aspects, the present disclosure provides a cooling system for mitigating fuel nozzle coking and a related method so as to provide cooling air from an onboard cooling blower to an aircraft's engine post shutdown for mitigating fuel nozzle coking in the aircraft's engine.

While the foregoing description relates generally to a gas turbine engine, the gas turbine engine may be implemented in various environments. For example, the engine may be implemented in an aircraft, but may also be implemented in non-aircraft applications, such as power generating stations, marine applications, or oil and gas production applications. Thus, the present disclosure is not limited to use in aircraft.

Further aspects of the present disclosure are provided by the subject matter of the following clauses.

A cooling system for post-shutdown cooling of an aircraft engine using an aircraft's environmental control system (ECS) including a cooling blower and a valve system. The valve system includes a blower valve disposed within the ECS between the cooling blower and the engine for enabling fluid communication between the cooling blower and the engine post shutdown of the engine and for disabling fluid communication between the cooling blower and the engine during operation of the engine and at least one ECS valve disposed within the ECS between a cabin of the aircraft and the engine for enabling fluid communication between the engine and the cabin of the aircraft during operation of the engine and for disabling fluid communication between the cooling blower and the cabin of the aircraft post shutdown of the engine.

The gas turbine engine according to the preceding clause, wherein the blower valve and the at least one ECS valve are solenoid valves.

The gas turbine engine according to any preceding clause, wherein the at least one ECS valve is disposed between the cooling blower and an auxiliary power unit (APU) of the aircraft for disabling fluid communication between the cooling blower and the APU of the aircraft post shutdown of the engine.

The gas turbine engine according to any preceding clause, wherein the at least one ECS valve includes a first ECS valve disposed between the cabin of the aircraft and a righthand side engine of the aircraft for controlling a flow of air from the righthand side engine of the aircraft to a first Pneumatic Air Cycle Kit (PACK) of the ECS and a second ECS valve disposed between the cabin of the aircraft and a lefthand side engine of the aircraft for controlling the flow of air from the lefthand side engine of the aircraft to a second PACK of the ECS.

The gas turbine engine according to any preceding clause, wherein activation and deactivation of the cooling blower is controlled manually via at least one control mechanism disposed within the aircraft.

The gas turbine engine according to any preceding clause, wherein the control mechanism is disposed within a cockpit of the aircraft.

The gas turbine engine according to any preceding clause, further comprising a temperature sensor disposed within the engine and configured to sense a temperature of the engine, wherein the cooling blower is deactivated in response to a sensed temperature of the engine being below a threshold temperature.

The gas turbine engine according to any preceding clause, further comprising a timer configured to be initiated in response to activation of the cooling blower, wherein the cooling blower is deactivated in response to an expiration of a predetermined period of time monitored by the timer.

The gas turbine engine according to any preceding clause, wherein the cooling blower is activated for about twenty minutes to about sixty minutes to cool the engine after shutdown of the engine.

A cooling system for post shutdown cooling of an aircraft engine using an aircraft's environmental control system (ECS) includes a cooling blower, a blower valve disposed within the ECS between the cooling blower and the engine for enabling fluid communication between the cooling blower and the engine post shutdown of the engine and for disabling fluid communication between the cooling blower and the engine during operation of the engine, and at least one ECS valve disposed within the ECS between a cabin of the aircraft and the engine for enabling fluid communication between the engine and the cabin of the aircraft during operation of the engine and for disabling fluid communication between the cooling blower and an auxiliary power unit (APU) of the aircraft post shutdown of the engine.

The cooling system according to the preceding clause, wherein the at least one ECS valve is disposed between the engine and the APU of the aircraft for disabling fluid communication between the engine and the APU of the aircraft post shutdown of the engine.

The cooling system according to any preceding clause, wherein the blower valve is disposed between the cooling blower and the ECS.

The cooling system according to any preceding clause, wherein the blower valve and the at least one ECS valve are solenoid valves.

The cooling system according to any preceding clause, wherein the at least one ECS valve includes a first ECS valve disposed between the cabin of the aircraft and a righthand side engine of the aircraft for controlling a flow of air from the righthand side engine of the aircraft to a first Pneumatic Air Cycle Kit (PACK) of the ECS and a second ECS valve disposed between the cabin of the aircraft and a lefthand side engine of the aircraft for controlling the flow of air from the lefthand side engine of the aircraft to a second PACK of the ECS.

The cooling system according to any preceding clause, further comprising a temperature sensor disposed within the engine and configured to sense a temperature of the engine, wherein the cooling blower is deactivated in response to a sensed temperature of the engine being below a threshold temperature.

The cooling system according to any preceding clause, further comprising a timer configured to be initiated in response to activation of the cooling blower, wherein the cooling blower is deactivated in response to an expiration of a predetermined period of time monitored by the timer.

A method for post-shutdown cooling an aircraft engine using an aircraft's environmental control system (ECS) includes initiating shutdown of an engine of an aircraft, opening a first valve to enable fluid communication via the ECS between a cooling blower onboard the aircraft and the engine of the aircraft, closing at least one second valve to disable fluid communication via the ECS between the cooling blower and an auxiliary power unit (APU) of the aircraft, and activating the cooling blower to provide cooling air to the engine via the ECS for cooling the engine post shutdown.

The method according to the preceding clause, further comprising deactivating the cooling blower, closing the first valve to disable fluid communication via the ECS between the cooling blower and the engine, and opening the at least one second valve to enable fluid communication via the ECS between the engine and a cabin of the aircraft.

The method according to any preceding clause, wherein deactivating the cooling blower includes deactivating the cooling blower in response to a sensed temperature of the engine being below a predetermined threshold temperature.

The method according to any preceding clause, wherein deactivating the cooling blower includes deactivating the cooling blower in response to expiration of a predetermined period of time.

The aspects disclosed herein are examples of the disclosure and may be embodied in various forms. For instance, although certain aspects herein are described as separate aspects, each of the aspects herein may be combined with one or more of the other aspects herein. Specific structural and functional details disclosed herein are not to be interpreted as limiting, but as a basis for the claims and as a representative basis for teaching one skilled in the art to variously employ this disclosure in virtually any appropriately detailed structure.

The phrases “in an aspect,” “in aspects,” “in various aspects,” “in some aspects,” or “in other aspects” may each refer to one or more of the same or different aspects in accordance with this disclosure.

1. A cooling system for post shutdown cooling of an aircraft engine using an aircraft's environmental control system (ECS), the cooling system comprising:
a cooling blower; and
a valve system including:
a blower valve disposed within the ECS between the cooling blower and the engine for enabling fluid communication between the cooling blower and the engine post shutdown of the aircraft engine and for disabling fluid communication between the cooling blower and the aircraft engine during operation of the engine; and
at least one ECS valve disposed within the ECS between a cabin of the aircraft and the aircraft engine for enabling fluid communication between the aircraft engine and the cabin of the aircraft during operation of the aircraft engine and for disabling fluid communication between the cooling blower and the cabin of the aircraft post shutdown of the aircraft engine; and
a temperature sensor disposed within the aircraft engine and configured to sense a temperature of the aircraft engine,
wherein the cooling blower is deactivated and the blower valve is closed in response to a sensed temperature of the aircraft engine being below a coking temperature for a fuel for the aircraft.

2. The cooling system according to claim 1, wherein the blower valve and the at least one ECS valve are solenoid valves.

3. The cooling system according to claim 1, wherein the at least one ECS valve is disposed between the cooling blower and an auxiliary power unit (APU) of the aircraft for disabling fluid communication between the cooling blower and the APU of the aircraft post shutdown of the aircraft engine.

4. The cooling system according to claim 1, wherein the at least one ECS valve includes:
a first ECS valve disposed between the cabin of the aircraft and a righthand side engine of the aircraft for controlling a flow of air from the righthand side engine of the aircraft to a first Pneumatic Air Cycle Kit (PACK) of the ECS; and
a second ECS valve disposed between the cabin of the aircraft and a lefthand side engine of the aircraft for controlling the flow of air from the lefthand side engine of the aircraft to a second PACK of the ECS.

5. The cooling system according to claim 1, wherein activation and deactivation of the cooling blower is controlled manually via at least one control mechanism disposed within the aircraft.

6. The cooling system according to claim 5, wherein the at least one control mechanism is disposed within a cockpit of the aircraft.

7. (canceled)

8. The cooling system according to claim 1, further comprising a timer configured to be initiated in response to activation of the cooling blower, wherein the cooling blower is deactivated in response to an expiration of a predetermined period of time monitored by the timer.

9. The cooling system according to claim 1, wherein the cooling blower is activated for about twenty minutes to about sixty minutes to cool the aircraft engine post shutdown of the aircraft engine.

10. A cooling system for post shutdown cooling of an aircraft engine using an aircraft's environmental control system (ECS), the cooling system comprising:
a cooling blower;
a blower valve disposed within the ECS between the cooling blower and the engine for enabling fluid communication between the cooling blower and the engine post shutdown of the engine and for disabling fluid communication between the cooling blower and the engine during operation of the engine; and
at least one ECS valve disposed within the ECS between a cabin of the aircraft and the engine for enabling fluid communication between the engine and the cabin of the aircraft during operation of the engine and for disabling fluid communication between the cooling blower and an auxiliary power unit (APU) of the aircraft post shutdown of the engine.

11. The cooling system according to claim 10, wherein the at least one ECS valve is disposed between the engine and the APU of the aircraft for disabling fluid communication between the engine and the APU of the aircraft post shutdown of the engine.

12. The cooling system according to claim 10, wherein the blower valve is disposed between the cooling blower and the ECS.

13. The cooling system according to claim 10, wherein the blower valve and the at least one ECS valve are solenoid valves.

14. The cooling system according to claim 10, wherein the at least one ECS valve includes:
a first ECS valve disposed between the cabin of the aircraft and a righthand side engine of the aircraft for controlling a flow of air from the righthand side engine of the aircraft to a first Pneumatic Air Cycle Kit (PACK) of the ECS; and
a second ECS valve disposed between the cabin of the aircraft and a lefthand side engine of the aircraft for controlling the flow of air from the lefthand side engine of the aircraft to a second PACK of the ECS.

15. The cooling system according to claim 10, further comprising a temperature sensor disposed within the engine and configured to sense a temperature of the engine, wherein the cooling blower is deactivated in response to a sensed temperature of the engine being below a threshold temperature.

16. The cooling system according to claim 10, further comprising a timer configured to be initiated in response to activation of the cooling blower, wherein the cooling blower is deactivated in response to an expiration of a predetermined period of time monitored by the timer.

17. A method for post shutdown cooling of an aircraft engine using the aircraft's environmental control system (ECS), the method comprising:
initiating shutdown of an engine of an aircraft;
opening a first valve to enable fluid communication via the ECS between a cooling blower onboard the aircraft and the engine of the aircraft;
closing at least one second valve to disable fluid communication via the ECS between the cooling blower and an auxiliary power unit (APU) of the aircraft; and
activating the cooling blower to provide cooling air to the engine via the ECS for cooling the engine post shutdown.

18. The method according to claim 17, further comprising:
deactivating the cooling blower;
closing the first valve to disable fluid communication via the ECS between the cooling blower and the engine; and
opening the at least one second valve to enable fluid communication via the ECS between the engine and a cabin of the aircraft.

19. The method according to claim 18, wherein deactivating the cooling blower includes deactivating the cooling blower in response to a sensed temperature of the engine being below a predetermined threshold temperature.

20. The method according to claim 18, wherein deactivating the cooling blower includes deactivating the cooling blower in response to expiration of a predetermined period of time.
